(19) United States
(12) Patent Application Publication
(10) Pub. No.: US 2009/0115192 A1
(43) Pub. Date: May 7, 2009

(54) Water wave-based energy generator

(76) Inventor: Donald R. Morrison, Hot Springs, AR (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/318,230

(22) Filed: Dec. 23, 2008

Related U.S. Application Data
(63) Continuation-in-part of application No. 11/483,088, filed on Jul. 10, 2006, now abandoned.
(60) Provisional application No. 60/755,772, filed on Jan. 4, 2006.

(51) Int. Cl. F03B 13/18

(52) U.S. Cl. 290/53

(57) ABSTRACT

The water wave-based energy generator is a system for extracting usable mechanical energy from a body of water, such as an ocean. A support frame is provided having a central portion, which is suspended over the body of water, and a plurality of legs, extending downwardly therefrom. A pivotal frame is pivotally joined to the central portion of the support frame and has a planar sheet mounted on a lower end thereof. The planar sheet is at least partially suspended in the body of water so that waves in the body of water cause rotation of the planar sheet and the pivotal frame with respect to the support frame. An elongated rod is pivotally joined at a proximal end thereof to the pivotal frame so that rotation of the pivotal frame generates lateral movement in the elongated rod. The lateral movement of the distal end of the elongated rod may be used to drive an external mechanically driven system.

### CROSS-REFERENCE TO RELATED APPLICATION

This application is a continuation-in-part of U.S. patent application Ser. No. 11/483,088, filed Jul. 10, 2006, which claimed the benefit of U.S. Provisional Patent Application Ser. No. 60/755,772, filed Jan. 4, 2006.

### BACKGROUND OF THE INVENTION

1. Field of the Invention

The present invention relates to a water wave-based energy generator, which is a system for extracting usable mechanical energy from a body of water, such as an ocean. Particularly, a planar sheet is mounted to a pivotal frame, which is suspended in the body of water, and natural waves within the body of water cause the planar sheet and pivotal frame to rotate. This rotation is translated into usable mechanical energy for powering an external mechanically driven system.

2. Description of the Related Art

Systems for the extraction of usable energy from bodies of water, such as an ocean, are known in the art. One such system utilizes a series of floats, which are mechanically linked to a rotational system, such that vertical motion of each float caused by a wave drives rotation of an axle. The multiplicity of floats are all mechanically interconnected, and the gear-transfer system required to translate the motion into rotational energy is complex, requiring a large number of mechanical parts which must be maintained in perfect alignment.

Similarly, a wide variety of other systems for converting water wave energy into usable energy have been utilized, such as propellers suspended under the surface of the water to tap into the energy of the transverse water currents, and these systems also require complex mechanical interconnections with a large number of mechanical parts requiring precision alignment. These systems, however, are used in oceans and similar environments. They are constantly under mechanical stress and strain, are subjected to heavy waves and currents, are exposed to the environment and are subject to quick corrosion.

It would be preferable to provide an energy extraction system that does not rely on complex mechanical interconnections or easily misaligned energy translation systems. Thus, a water wave-based energy generator solving the aforementioned problems is desired.

### SUMMARY OF THE INVENTION

The water wave-based energy generator is a system for extracting usable mechanical energy from a body of water, such as an ocean. A support frame is provided having a central portion, which is suspended over the body of water, and is further provided with a plurality of legs extending downwardly therefrom. The legs are embedded in a support surface, such as the ocean floor. A pivotal frame is pivotally joined to the central portion of the support frame and has a planar sheet mounted on a lower end thereof. The planar sheet is at least partially suspended in the body of water so that waves in the body of water cause rotation of the planar sheet and the pivotal frame with respect to the support frame. Further, user-adjustable masses may be supported on the pivotal frame, allowing the user to control the resistance to motion of the pivoting system.

An elongated rod is pivotally joined at a proximal end thereof to the pivotal frame so that rotation of the pivotal frame generates lateral movement in the elongated rod. The lateral movement of the distal end of the elongated rod may be used to drive an external mechanically driven system. The elongated rod may be a linear gear. Lateral movement of the linear gear can be translated directly into rotational motion through interconnection with a rotational gear. The power output of the system may be controlled by the addition or subtraction of mass from the user-adjustable masses.

These and other features of the present invention will become readily apparent upon further review of the following specification and drawings.

### BRIEF DESCRIPTION OF THE DRAWINGS

FIG. 1 is a side schematic view of a water wave-based energy generator according to the present invention.

FIG. 2 is a perspective view of an energy transfer system of the water wave-based energy generator of the present invention.

FIG. 3 is a schematic view illustrating the rotation of a pivotal frame and associated planar sheet of the subject water wave-based energy generator.

FIG. 4 is a perspective view of an alternative embodiment of the water wave-based energy generator according to the present invention.

FIG. 5 is a front, partial schematic view of another alternative embodiment of the water wave-based energy generator according to the present invention.

FIG. 6 is a top, partial schematic view of the water wave-based energy generator of FIG. 5.

Similar reference characters denote corresponding features consistently throughout the attached drawings.

### DETAILED DESCRIPTION OF THE PREFERRED EMBODIMENTS

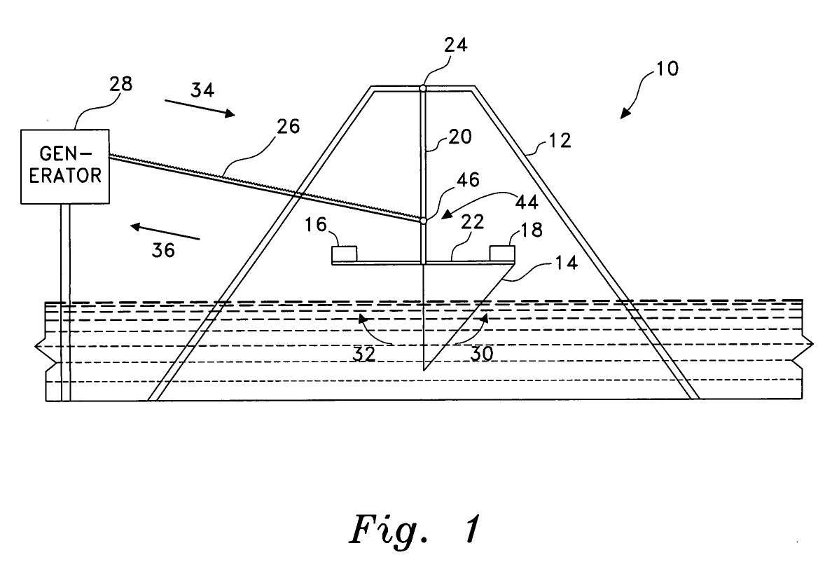

The water wave-based energy generator 10, shown in FIG. 1, provides a system for extracting usable mechanical energy from the natural waves passing through a body of water, such as an ocean, sea or large lake, for example. As will be described in greater detail below, a planar sheet 14 is at least partially submerged in the body of water, and is mounted on a pivotal frame 44. Due to conservation of momentum, waves striking the planar sheet 14 cause the planar sheet 14 and the pivotal frame 44 to rotate, and this rotation is then translated into mechanical energy for driving an external system, such as, for example, a separate mechanically driven motor or an electrical generator.

As shown in FIG. 1, a support frame 12 is placed in the body of water to support the planar sheet 14, which is at least partially submerged in the water. The support frame 12 has a central region and a plurality of legs, which extend downward and are embedded in a support surface, such as the ocean floor. Alternatively, the frame 12 could be built on a separate structure, such as a dock or a barge, with planar sheet 14 being held within the water.

Representative dimensions of the support frame 12 would include a support frame 12 with legs submerged in approximately nine feet of ocean water, with each leg being approximately forty-eight feet long, with a spacing between adjacent legs being approximately seventy-two feet. The support frame 12 is preferably formed from a sturdy material that is resistant to corrosion by salt water, such as aluminum, stainless steel or the like.

A pivotal frame 44 is suspended from the central portion of support frame 12 by a pivotal mounting 24. Pivotal mounting 24 may include pillow block bearings or the like. The support frame includes a vertical support 20 and a horizontal support 22. Corresponding to the dimensions given above for the support frame 12, the vertical support 20 has a length of approximately thirty-six feet, and the horizontal support 22 has a length of approximately thirty-two feet. The vertical and horizontal supports 20, 22 are preferably formed from a sturdy material which is resistant to corrosion by salt water, such as aluminum, stainless steel or the like, similar to support frame 12.

As shown, the planar sheet 14 is fixed to the lower end of pivotal support 44, and extends into the body of water. Although shown as having a substantially triangular shape, planar sheet 14 may have any desired shape and dimensions. The planar sheet 14 is formed from a material that can withstand the fluid currents it will be subjected to in use, and also that will not corrode in salt water. Preferably, the planar sheet 14 is lightweight, so that the sheet 14 does not add appreciable mass to the system, and may be formed from aluminum, plastic, treated lumber or the like.

Removable and adjustable masses 16 and 18 are supported on horizontal support 22, as shown. Through selective addition or subtraction of mass from horizontal support 22, the user may control how much power is to be generated by system 10. Further, depending on the natural waves and currents, which the user cannot control, it may be necessary to provide greater inertial resistance in order to maintain the rotating parts of system 10 in alignment, particularly during storms and the like.

In use, a wave impinging upon planar sheet 14, with the wave heading towards the right in FIG. 1, will cause pivotal frame 44 and planar sheet 14 to pivot about pivot point 24, in the direction indicated by arrow 30. As shown, an elongated rod 26 is pivotally attached to vertical support 20 at pivotal mounting 46. The elongated rod 26 is preferably a linear gear, as shown.

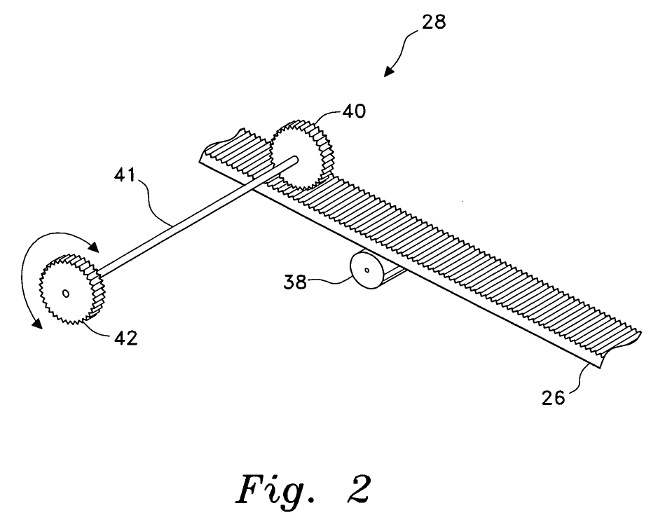

As vertical support 20 pivots along direction 30, elongated rod 26 is drawn in the direction indicated by arrow 34. The distal end of elongated rod 26 is connected to an energy transfer system or generator 28, as will be described below, with specific reference to FIG. 2. This induced movement of elongated rod 26 drives the energy transfer system or generator 28 for the creation of usable mechanical energy.

Under the weight of gravity, frame 44 rotates in the opposite direction once the wave passes, indicated by directional arrow 32, like a pendulum. This rotation causes a similar translation in position for elongated rod 26, now in the direction indicated by directional arrow 36. This movement is also converted into usable energy by system 28. This induced oscillatory movement of elongated rod 26 is what generates the mechanical energy that may be used to power external systems.

The internal components of energy transfer system 28 are shown in FIG. 2. As shown, the distal end of elongated rod 26, which is preferably a linear gear, contacts a rotating gear 40. Rotating gear may be a simple gear or may be a ratcheting gear, allowing for rotation in only one direction. The lateral movement of elongated rod 26 caused by the water wave drives rotating gear 40 to rotate. Gear 40 is, in turn, connected by an axle to a drive gear 42. Drive gear 42 may be connected directly to a mechanically driven system, or may power an electric generator or the like. Elongated rod 26 is mounted on a guide wheel 38, as shown, in order to maintain proper alignment between the elongated rod 26 and the rotational gear 40.

In order to approximate the range of energies that may be extracted from the ocean utilizing system 10, we can model frame 44 as a pair of pendula. If vertical and horizontal supports 20, 22, as well as planar sheet 14, have masses far less than those of masses 16, 18, then the rotation of masses 16, 18 about pivot 24 will approximate to the rotation of two pendula, one with mass 16 and one with mass 18, moving at the same angular velocity at all times about pivot point 24.

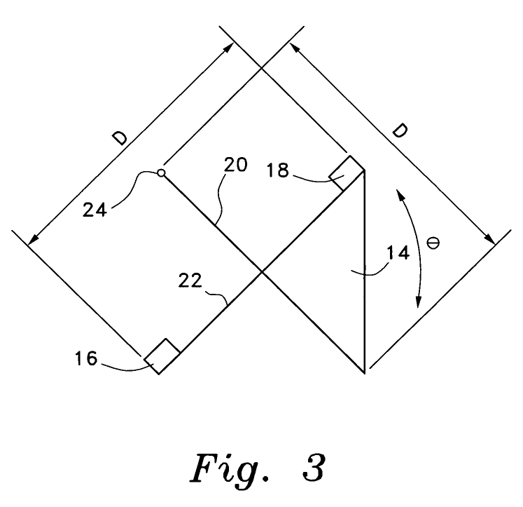

Referring to FIG. 3, if horizontal support 22 has a length D and vertical support 20 also has a length D (it should be noted that the equality in length is for purposes of simplifying this calculation only; the lengths of each support do not have to be equal), and the entire system rotates by an angle θ, as shown, then each of the masses 16, 18 moves vertically by a distance of h, where h is given by:

$$h = ( \frac{D}{\sqrt{2}} ) ( 1 - cos ( θ ) ) . \qquad ( 1 )$$

For purposes of simplifying the calculation, we can set both masses of weights 16, 18 to M, and we exclude such real-life factors as water resistance, etc. Once again, the equivalence of mass is for purposes of simplifying the calculation only, and the masses of weights 16, 18 do not need to be equivalent. For purposes of this approximation only, the amount of energy E required to rotate the frame, which can then be extracted via system 28, is given by

E=2·Mgh=\sqrt{2}·MgD(1−cos(θ)), (2)

where g is the standard gravitational acceleration of 9.8 m/s². Thus, for a sample mass of M=1000 kg rotated over an angle of 10°, with D equal to 36 feet, for example, we get E=2310.4 J.

The action of a wave on the system 10 does not take relatively long, so for an exemplary time of rotation of 1 s., we get a power production of approximately 2.3 KW from a simple rotation by water wave of 100. This power may be transferred directly into usable mechanical power via system 28 and linkage to an external mechanically driven system. This sample calculation is only an approximation to give an order of energies and powers that may be produced by system 10. Further, it should be noted that this calculation was performed for a single such system 10; multiple systems, such as system 10, could be distributed over a body of water as an “energy farm” and linked together.

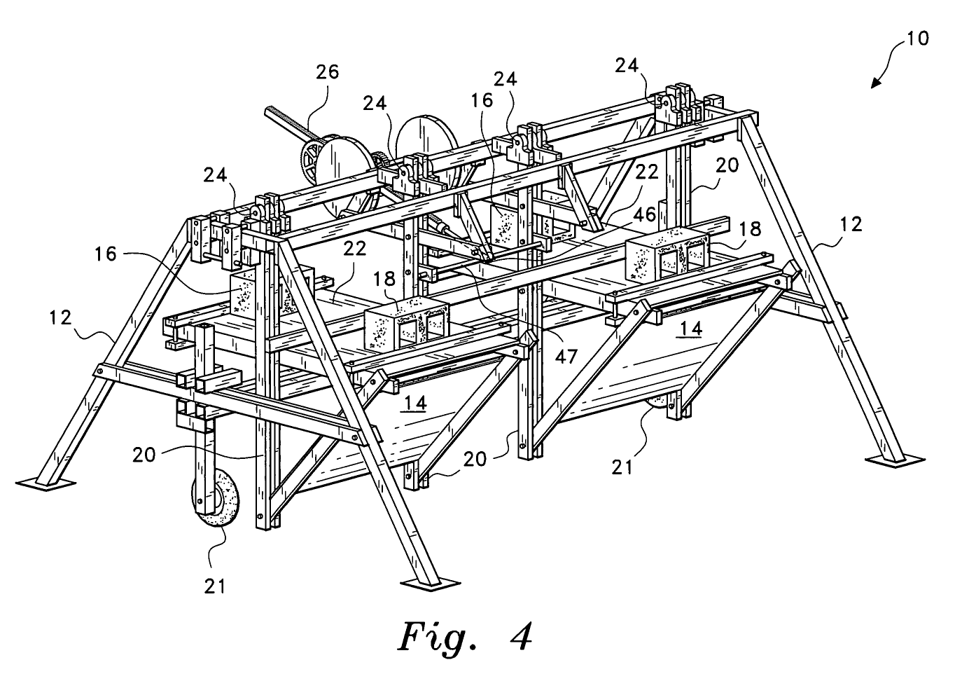

As illustrated in the embodiment of FIG. 4, system 10 may include a plurality of sheets 14 (herein shown as a pair of sheets 14, though it should be understood that any suitable number may be utilized), each being secured to a respective vertical support 20 and horizontal support 22. As shown, the horizontal supports 22 may be formed from substantially planar boards or sheets, suspended between of a pair of vertical frame members, forming vertical supports 20. In this embodiment, elongated rod 26 is pivotally joined to frame 44 at pivot 46, which is mounted on a central shaft 47, joining the vertical frame members of vertical supports 20.

It should be understood that system 10 may have any desired dimensions or configuration. For example, relatively small systems 10 may be utilized for individual or small-business usage, and larger systems 10 may be utilized for large-scale energy production. In the preferred embodiment, systems 10 may produce, for example, between approximately 14 KW and 2000 KW of power, depending upon the selected size and removable mass chosen for the system 10. For large-scale systems 10, additional weighting members may be further utilized, mounted to frame 12, for anchoring the system 10 within the ocean bed or the like. Further, a small-scale portable system may include wheels 21 (shown in the embodiment of FIG. 4), or the like, pivotally mounted to the lower end of the support frame 12, allowing the system 10 to be easily transported to a desired power-generation site.

System 10 may be operated continuously, as it relies on power generated from ocean waves or the like, rather than an external man-made power source. As the system employs a direct mechanical drive, the components of system 10 may be easily replaced or repaired. Further, a simple on-off type switch may be provided for ceasing power production when desired.

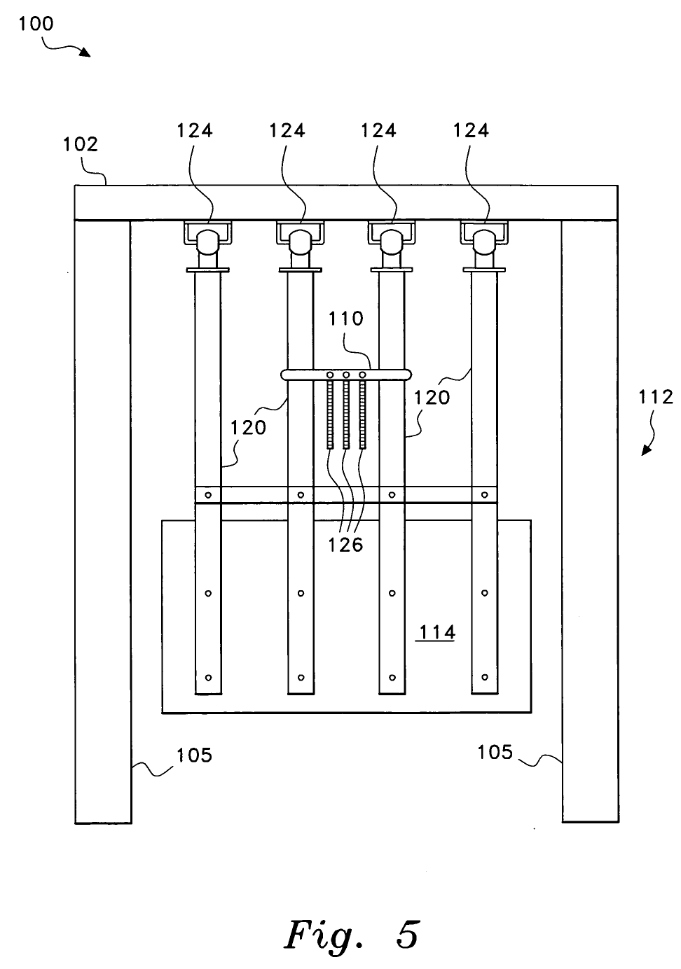

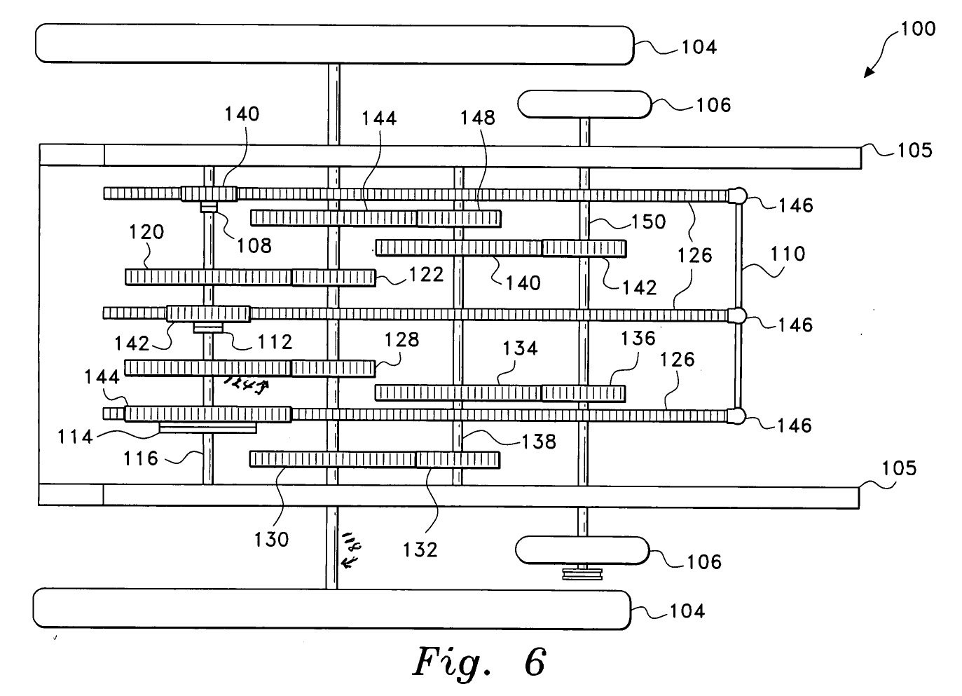

The alternative embodiment of the water wave-based energy generator 100, shown in FIGS. 5 and 6, functions in a manner similar to that described above with regard to the embodiments of FIGS. 1-4, including a planar sheet 114, which is pivotally secured to an external frame 112. The frame 112 is formed from at least a pair of side rails or supports 105 and an upper rail or support 102. A plurality of vertical supports 120 are pivotally joined at their upper ends to the upper rail 102 by pivotal mountings 124, and at their lower ends to the planar sheet 114, so that planar sheet 114 is driven to rotate with respect to the frame 112 by the energy of the water waves, as described above with regard to the embodiments of FIGS. 1-4.

Generator 100, however, includes a plurality of linear gears 126, rather than the single linear gear 26 of FIGS. 1-4. As best shown in FIG. 5, the planar sheet 114 is preferably supported by four vertical supports 120, with a horizontal support 110 joining the inner pair thereof. The horizontal support 110 is secured at either end to a central portion of the central pair of vertical supports 120, as shown. A plurality of linear gears 126, similar to linear gear 26, are pivotally secured to horizontal support 110 by pivotal attachments 146. Pivotal attachments 146 may be any suitable type of pivoting connector. Although FIGS. 5 and 6 illustrate the use of three such linear gears 126, it should be understood that any suitable number may be utilized.

As shown in FIG. 6, a first axle 116 is rotatably secured between the pair of side supports 105. Three gears 140, 142 and 144 are secured to first axle 116 for selective, respective contact with one of the linear gears 126. Preferably, each of gears 140, 142 and 144 has a different diameter, allowing for differing rates of rotation for a constant linear translation of linear gears 126. For example, gear 140 may have a diameter of four inches, gear 142 may have a diameter of six inches, and gear 144 may have a diameter of twelve inches. Each of gears 140, 142, 144 has a respective clutching mechanism 108, 112, 114 associated therewith, allowing the user to select the rate of rotation of first axle 116 by selecting one of the gears 140, 142, 144. Alternatively, gears 140, 142, 144 may be ratcheting gears. By selecting which gear engages the respective one of linear gears 126, the user may selectively control the rate of power generation. For the same rate of linear translation of linear gears 126, gear 140 (using the exemplary dimensions given above) may rotate at, for example 180 RPM, gear 142 may rotate at 270 RPM, and gear 144 may rotate at 540 RPM.

Driven rotation of first axle 116 drives rotation of a pair of gears 120, 124, which are also mounted to first axle 116. Gears 120, 124 preferably have equal diameters. For the example of gear diameters given above, gears 120, 124 may have diameters of approximately twelve inches. A second axle 118 is also rotatably mounted between side supports 105. Gears 122, 128, which may have exemplary diameters of approximately six inches, are mounted on second axle 118 and engage the pair of gears 120, 124 to drive rotation of second axle 118. As shown, plates 104 are mounted to the opposed ends of second axle 118. Plates 104 are preferably circular and may each have a diameter of, for example, approximately four feet. If formed of steel, for example, each plate would have a weight of approximately 2,000 pounds.

Each plate 104 is connected to an external electric generator system by a pulley, belt, chain, gearing system or the like. Linear motion of linear gears 126, generated by the pivoting of planar sheet 110, is translated into rotational motion of plates 104 for driving an external generator, as described above with regard to the embodiments of FIGS. 1-4.

A third axle 138 is also rotatably mounted between side supports 105. A pair of gears 130, 144, which may be twelve-inch diameter gears, for example, are mounted on second axle 118, as shown, for driving rotation of a pair of gears 132, 148, mounted on third axle 138. Gears 132, 148 may each have a diameter of approximately six inches, for example. A second set of gears 134, 140 are also mounted on third axle 138, each having a diameter of approximately twelve inches. Gears 134, 140 drive rotation of a pair of gears 136, 142, which may be six inch diameter gears, for example, mounted on a fourth axle 150, which is preferably also rotatably mounted to side supports 105. A pair of smaller, auxiliary plates 106 are mounted on either end of fourth axle 150, as shown. In the example given above, plates 104 each have a weight of approximately 2,000 pounds. Auxiliary plates 106 may each have a weight of approximately 500 pounds, for producing an smaller, auxiliary rotational energy. An external generator system may be connected to plates 106 by any suitable connection, as described above with regard to plates 104.

It is to be understood that the present invention is not limited to the embodiments described above, but encompasses any and all embodiments within the scope of the following claims.

I claim:

1. A water wave-based energy generator, comprising:
a support frame having a central portion and a plurality of support legs extending downwardly therefrom, the central portion of the support frame being adapted for positioning over a body of water;
a pivotal frame having an upper end a lower end, the upper end being pivotally secured to the central portion of the support frame;
a planar sheet attached to the lower end of the pivotal frame, the planar sheet being at least partially suspended in the body of water;
a plurality of elongated rods, each of the rods having a proximal end and a distal end, the proximal end being pivotally joined to the pivotal frame; and
means for mechanically coupling the plurality of elongated rods to an external mechanically driven system;
wherein water waves in the body of water drive the planar sheet and the pivotal frame to rotate with respect to the support frame, rotation of the planar sheet causing the plurality of elongated rods to move in a lateral direction, the distal ends of the elongated rods being adapted for transferring lateral movement of the rods to the external mechanically driven system.

2. The water wave-based energy generator as recited in claim 1, wherein each said elongated rod is a linear gear.

3. The water wave-based energy generator as recited in claim 2, further comprising:
a plurality of first rotational gears, each of the rotational gears being in contact with a respective one of the distal ends of said elongated rods, lateral movement of said elongated rods driving the rotational gears to rotate;
a first axle, the plurality of first rotational gears being mounted on the first axle adjacent said elongated rods; and
at least one first drive gear mounted on the first axle.

4. The water wave-based energy generator as recited in claim 3, wherein each of said first rotational gears has a different diameter, the water wave-based energy generator further comprising a plurality of clutch mechanisms, each of the clutch mechanisms being coupled to a respective one of said first rotational gears, whereby the user may selectively engage a selected one of said first rotational gears.

5. The water wave-based energy generator as recited in claim 4, further comprising:
a second axle rotatably mounted to said support frame;
a pair of plates mounted on opposed ends of the second axle, each of the plates being adapted for mechanical connection to the external mechanically driven system;
at least one second rotational gear mounted on the second axle, the at least one second rotational gear engaging the at least one first drive gear, rotation of the at least one first drive gear causing rotation in the at least one second rotational gear, thereby driving rotation of the pair of plates; and
at least one second drive gear mounted on the second axle.

6. The water wave-based energy generator as recited in claim 5, further comprising:
a third axle rotatably mounted to said support frame;
at least one third rotational gear mounted on the third axle, the at least one third rotational gear engaging the at least one second drive gear, rotation of the at least one second drive gear causing rotation in the third axle; and
at least one third drive gear secured to the third axle.

7. The water wave-based energy generator as recited in claim 6, further comprising:
a fourth axle rotatably mounted to said support frame;
a pair of auxiliary plates mounted on opposed ends of the fourth axle, each of the auxiliary plates being adapted for mechanical connection to an external, auxiliary mechanically driven system; and
at least one fourth rotational gear mounted on the fourth axle, the at least one fourth rotational gear engaging the at least one third drive gear, rotation of the at least one third drive gear causing rotation in the at least one fourth rotational gear, thereby driving rotation of the auxiliary plates.

8. The water wave-based energy generator as recited in claim 1, wherein said pivotal frame comprises a vertical support member and a horizontal support member, the horizontal support member having a proximal end and a distal end, said planar sheet being joined to the proximal end of the horizontal support member.

9. The water wave-based energy generator as recited in claim 8, further comprising a user-selectable distal weighting member removably mounted on the distal end of the horizontal support member.

10. The water wave-based energy generator as recited in claim 9, further comprising a user-selectable proximal weighting member removably mounted on the proximal end of the horizontal support member.

11. A water wave-based energy generator, comprising:
a support frame having a central portion and a plurality of support legs extending downwardly therefrom, the central portion of the support frame being adapted for positioning over a body of water;
a pivotal frame having an upper end a lower end, the upper end being pivotally secured to the central portion of the support frame;
a planar sheet secured to the lower end of the pivotal frame, the planar sheet being at least partially suspended in the body of water;
a plurality of elongated rods, each of the rods having a proximal end and a distal end, the proximal end being pivotally joined to the pivotal frame;
a plurality of first rotational gears, each of the rotational gears being in contact with a respective one of the distal ends of the elongated rods, lateral movement of the elongated rods driving the rotational gears to rotate;
a first axle, the first rotational gears being mounted on the first axle adjacent the elongated rods; and
at least one first drive gear mounted on the first axle;
wherein water waves in the body of water drive the planar sheet and the pivotal frame to rotate with respect to the support frame, rotation of the planar sheet causing the plurality of elongated rods to move in a lateral direction, the distal ends of the elongated rods being adapted for transferring the lateral movement to an external mechanically driven system.

12. The water wave-based energy generator as recited in claim 11, wherein each said elongated rod is a linear gear.

13. The water wave-based energy generator as recited in claim 12, wherein each of said first rotational gears has a different diameter, the water wave-based energy generator further comprising a plurality of clutch mechanisms, each of the clutch mechanisms being coupled to a respective one of said first rotational gears, whereby the user may selectively engage a selected one of said first rotational gears.

14. The water wave-based energy generator as recited in claim 13, further comprising:
a second axle rotatably mounted to said support frame;
a pair of plates mounted on opposed ends of the second axle, each of the plates being adapted for mechanical connection to the external mechanically driven system;
at least one second rotational gear mounted on the second axle, the at least one second rotational gear engaging the at least one first drive gear, rotation of the at least one first drive gear causing rotation in the at least one second rotational gear, thereby driving rotation of the pair of plates; and
at least one second drive gear mounted on the second axle.

15. The water wave-based energy generator as recited in claim 14, further comprising:
a third axle rotatably mounted to said support frame;
at least one third rotational gear mounted on the third axle, the at least one third rotational gear engaging the at least one second drive gear, rotation of the at least one second drive gear causing rotation in the third axle; and
at least one third drive gear secured to the third axle.

16. The water wave-based energy generator as recited in claim 15, further comprising:
a fourth axle rotatably mounted to said support frame;
a pair of auxiliary plates mounted on opposed ends of the fourth axle, each of the auxiliary plates being adapted for mechanical connection to an external, auxiliary mechanically driven system; and
at least one fourth rotational gear mounted on the fourth axle, the at least one fourth rotational gear engaging the at least one third drive gear, rotation of the at least one third drive gear causing rotation in the at least one fourth rotational gear, thereby driving rotation of the auxiliary plates.

17. The water wave-based energy generator as recited in claim 11, wherein said pivotal frame comprises a vertical support member and a horizontal support member, the horizontal support member having a proximal end and a distal end, said planar sheet being joined to the proximal end of the horizontal support member.

18. The water wave-based energy generator as recited in claim 17, further comprising a user-selectable distal weighting member removably mounted on the distal end of the horizontal support member.

19. The water wave-based energy generator as recited in claim 18, further comprising a user-selectable proximal weighting member removably mounted on the proximal end of the horizontal support member.
